(19) United States
(12) Patent Application Publication
(10) Pub. No.: US 2011/0013344 A1
(43) Pub. Date: Jan. 20, 2011

(54) Polarizable electrode for capacitor and electric double layer capacitor having the same

(75) Inventors: Sergey Remizov, Suwon (KR); Hak Kwan Kim, Hanam (KR); Hyun Chul Jung, Yongin (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS, CO., LTD., Suwon (KR)

(21) Appl. No.: 12/654,424

(22) Filed: Dec. 18, 2009

(30) Foreign Application Priority Data
Jul. 17, 2009 (KR) 10-2009-0065535

(51) Int. Cl. H01G 9/058; B05D 5/12

(52) U.S. Cl. 361/502; 427/80; 977/742; 977/948

(57) ABSTRACT

There is provided a polarizable electrode for a capacitor and an electric double layer capacitor having the same. The polarizable electrode is a gel-state mixture including carbon nanotubes (CNTs) forming a network structure, porous carbon materials dispersed between the CNTs, and ionic liquids allowing the CNTs and the porous carbon materials to be dispersed. The polarizable electrode secures an electrical connection path between an electrode and a collector and prevents separation between the porous carbon materials and the ionic liquids using the network structure formed by the CNTs. Accordingly, the electric double layer capacitor having the polarizable electrode has low contact resistance between the electrode and the collector and has low possibility of polarization occurrence between the electrode and an electrolyte, resulting in high capacitance and high energy efficiency due to low equivalent series resistance.

### CROSS-REFERENCE TO RELATED APPLICATIONS

This application claims the priority of Korean Patent Application No. 10-2009-0065535 filed on Jul. 17, 2009, in the Korean Intellectual Property Office, the disclosure of which is incorporated herein by reference.

### BACKGROUND OF THE INVENTION

1. Field of the Invention

The present invention relates to a polarizable electrode for a capacitor and an electric double layer capacitor having the same, and more particularly, to a polarizable electrode for a capacitor that allows for higher power output and higher energy density and an electric double layer capacitor having the same.

2. Description of the Related Art

Super capacitors have characteristics which are between electrolytic capacitors and secondary batteries. In comparison with secondary batteries, super capacitors have faster charging times, offer longer life, allow for higher power output and have higher energy density.

Super capacitors may be divided into two types of capacitors according to the operational principle thereof. One is an electric double layer capacitor (EDLC) which stores an electrical charge in an electrical double layer of an electrode-electrolyte interface, and the other is a redox capacitor, called a pseudo capacitor, which accompanies a change in the oxidation state of a transition metal ion on the surface of a transition metal oxide and stores an electrical charge or an electron.

In general, an electric double layer capacitor has a pair of electrodes, formed of porous materials having a large specific surface area in order to allow for electrical absorption with cations and anions within an electrolyte, and a separation membrane with high insulation properties interposed between the pair of electrodes while each of the electrodes is impregnated with a liquid electrolyte. This electric double layer capacitor utilizes physical absorption and desorption. That is, charging is performed as the cations and the anions are respectively adsorbed onto a cathode and an anode when an electric field is applied from the outside, and discharging is performed as the adsorbed ions are desorbed by removing the electric field.

One of the most important factors in determining the power density of an electric double layer capacitor is proportional to the sum of resistance of all the components constituting the electric double layer capacitor. Here, the resistance includes diffusion resistance from a porous electrode layer to an electrolyte, contact resistance between an electrode and a collector, and resistance of the electrode material itself.

One of the most important factors in determining the performance of an electric double layer capacitor is the material selected to form electrodes. Here, electrode materials need to have high electrical conductivity, a large specific surface area, electrochemical stability, and low costs.

Only carbon-based electrode materials have so far enjoyed commercial success and are currently into production to manufacture electric double layer capacitors. In general, carbon-based electrodes are manufactured by mixing activated carbon, conductive materials, and a polymer binder. However, the polymer binder blocks the pores of the activated carbon and prevents ions from entering into the pores, thereby reducing capacitance. When the activated carbon is bonded by the polymer binder only, there may be the problem of a lack of mechanical strength. During rolling or compression molding, cracks or fractures may occur. Also, when the amount of the polymer binder is increased so as to improve mechanical strength, internal resistance may increase, and also the amount of activated carbon is relatively reduced, whereby capacitance per unit volume may be reduced.

Therefore, the amount of the polymer binder used needs to be reduced or limited when manufacturing electrodes.

Electrolytes used in electric double layer capacitors may be divided into aqueous electrolytes and non-aqueous electrolytes. Although there may be differences according to concentration, aqueous electrolytes may have an advantage in a reduction in the internal resistance of the electric double layer capacitor due to high electrical conductivity; however, they may have a disadvantage in having low energy density due to low electrical potential (applied voltage: 0.7 V to 1.2 V).

Also, although there may be differences according to type, non-aqueous organic electrolytes may have an advantage in having high energy density due to high electrical potential (applied voltage: approximately 2.3V); however, they may have a disadvantage in charging and discharging characteristics as compared to the aqueous electrolytes since they have higher viscosity as well as electrical conductivity approximately 100 times lower than that of the aqueous electrolytes.

### SUMMARY OF THE INVENTION

An aspect of the present invention provides a polarizable electrode for a capacitor that allows for higher power output and higher energy density and an electric double layer capacitor having the same.

According to an aspect of the present invention, there is provided a polarizable electrode for a capacitor, the polarizable electrode including: carbon nanotubes forming a network structure; porous carbon materials dispersed between the carbon nanotubes; and ionic liquids allowing the carbon nanotubes and the porous carbon materials to be dispersed. The polarizable electrode is a gel-state mixture.

The carbon nanotubes may have a cylinder shape and have a length to diameter ratio of 10:1 or greater.

The porous carbon materials may have an average diameter of 0.01 an to 100 μm and more preferably from 5 μm to 20 μm.

The ionic liquids may include at least one cation selected from the group consisting of alkylimidazolium, alkylsulfonium, alkylphosphonium, alkylammonium, alkylpyridinium and alkylpiperidinium.

The ionic liquids may include at least one anion selected from the group consisting of BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻, N(COCF₃)(SO₂CF₃)⁻, N(SO₂F)₂⁻, N(CN)₂⁻, (CN)₃⁻, SCN⁻, SeCN⁻, CuCl₂⁻, AlCl₄⁻, and F(HF)_{2.3}⁻.

The polarizable electrode may include conductive materials.

According to another aspect of the present invention, there is provided an electric double layer capacitor, the electric double layer capacitor including: first and second electrodes in a gel state including carbon nanotubes forming a network structure, porous carbon materials dispersed between the carbon nanotubes, and ionic liquids allowing the carbon nanotubes and the porous carbon materials to be dispersed; and an ion permeable separation membrane interposed between the first and second electrodes.

According to another aspect of the present invention, there is provided a method of manufacturing an electric double layer capacitor, the method including: manufacturing a gel-state mixture by mixing carbon nanotubes, porous carbon materials, and ionic liquids; manufacturing first and second electrodes by casting the mixture into collectors; and depositing an ion permeable separation membrane between the first and second electrodes and sealing all components.

The carbon nanotubes may include 0.1 to 10 parts by weight of the carbon nanotubes per 100 parts by weight of the mixture.

The porous carbon materials may include 5 to 20 parts by weight of the porous carbon materials per 100 parts by weight of the mixture.

The ionic liquids may include 70 to 90 parts by weight of the ionic liquids per 100 parts by weight of the mixture.

The mixture may have viscosity in a range of 1 cps to 100000 cps.

The mixture may have a Shear Thinning Ratio (STR) in a range of 1 to 10, the STR being expressed by Equation 1:

$$STR = \frac{{η}_{1}}{{η}_{2}} \qquad Equation 1$$

where η₁ is a viscosity of the mixture when applied shear rate is D, and η₂ is a viscosity of the mixture when applied shear rate is D×10.

The ion permeable separation membrane may be deposited after being impregnated with the ionic liquids.

Each manufacturing process of the electric double layer capacitor may be performed in a moistureless environment.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view schematically illustrating a polarizable electrode for a capacitor according to an exemplary embodiment of the present invention;

FIGS. 2A and 2B are cross-sectional views schematically illustrating an electric double layer capacitor according to an exemplary embodiment of the present invention;

FIG. 3 is a cross-sectional view schematically illustrating a part of manufacturing process of an electric double layer capacitor according to an exemplary embodiment of the present invention;

FIG. 4 is a graph illustrating the results of a cyclic voltammetry test of an electric double layer capacitor according to an exemplary embodiment of the present invention; and

FIG. 5A through 5D are graphs illustrating the results of a charging and discharging test on an electric double layer capacitor according to an exemplary embodiment of the present invention.

### DETAILED DESCRIPTION OF THE PREFERRED EMBODIMENT

Exemplary embodiments of the present invention will now be described in detail with reference to the accompanying drawings.

The invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

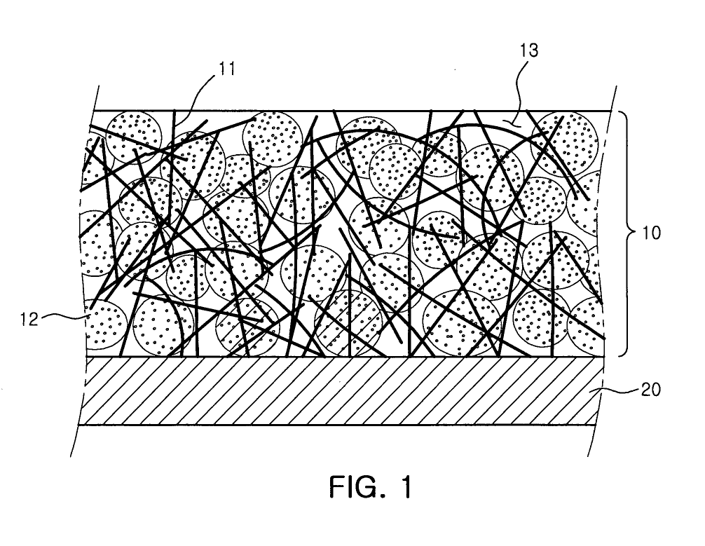

FIG. 1 is a cross-sectional view schematically illustrating a polarizable electrode for a capacitor according to an exemplary embodiment of the present invention.

A polarizable electrode 10 for a capacitor according to this embodiment includes carbon nanotubes (CNTs) 11 forming a network structure, porous carbon materials 12 dispersed between the CNTs, and ionic liquids 13 allowing the CNTs and the porous carbon materials to be dispersed. The polarizable electrode 10 utilizes the CNTs 11, the porous carbon materials 12, and the ionic liquids 13 as electrode materials, and a mixture thereof may form a gel. The polarizable electrode 10 is commonly formed on a metallic collector 20.

The CNTs 11 and the porous carbon materials 12 are present to be dispersed in the ionic liquids 13. The CNTs 11 form the network structure, and the porous carbon materials 12 and the ionic liquids 13 are bonded by the physical strength of the network structure. The network structure formed by the CNTs 11 may prevent separation between the porous carbon materials 12 and the ionic liquids 13 according to density differences therebetween or greatly reduce the speed of separation.

Conventionally, a polymer binder has been used for the bonding of porous carbon materials. However, the polymer binder blocks pores of the porous carbon materials and prevents ions from entering into the pores, thereby reducing capacitance. In order to avoid such a defect resulting from the use of the polymer binder, the porous carbon materials 12 in this embodiment are bonded by the CNTs 11.

Also, the CNTs 11 act as an electrical connection path between the porous carbon materials 12 and the collector 20 and reduce contact resistance between the electrode 10 and the collector 20.

The CNTs 11 have high electrical conductivity, but have disadvantages in high costs and low capacitance. In this embodiment, however, the capacitance is secured by the porous carbon materials 12. Accordingly, a small amount of CNTs is used, and the small amount of CNTs has an effect of a reduction in equivalent series resistance (ESR).

The CNTs 11 may be in the shape of a cylinder. Also, the CNTs 11 may be single-walled carbon nanotubes or multi-walled carbon nanotubes.

The CNTs 11 may be 5 nm to 15 nm in diameter and 50 nm to 1 mm, preferably 10 μm to 20 μm, in length.

A length to diameter ratio in the CNTs 11 may be 10 times or more, and more preferably may be 100 times or more.

The concentration of the CNTs 11 may be selected within the range allowing for gel formation. For example, 0.1 to 10 parts by weight of CNTs per 100 parts by weight of the entire mixture may be used. When less than 0.1 parts by weight of CNTs are used, gel formation ability may be degraded. When more than 10 parts by weight of CNTs are used, capacitance may be reduced or price competitiveness may be deteriorated.

The porous carbon materials 12 may have a large specific surface area so as to increase the capacitance of an electric double layer capacitor. The specific surface area of the porous carbon materials 12, measured by a BET method, may range from 100 m²/g to 2600 m²/g and more preferably from 1500 m²/g to 2000 m²/g. The average diameter of the porous carbon materials 12 may range from 0.01 μm to 100 μm and more preferably from 5 μm to 20 μm.

The porous carbon materials 12 are not particularly limited. For example, activated carbon with micropores or nanopores, inorganic nanoporous carbon, templated mesoporous carbon, carbon aerogel, carbon black, and the like may be used therefor.

In the case of the porous carbon materials 12, 5 to 20 parts by weight of porous carbon materials per 100 parts by weight of the entire mixture may be included. When less than 5 parts by weight of porous carbon materials are used, capacitance may be reduced. When more than 20 parts by weight of porous carbon materials are used, internal resistance may be increased and viscosity of the mixture may be too high.

Ionic liquids are mixed with CNTs to form a gel. In this embodiment, the ionic liquids 13 are mixed with the CNTs 11 and the porous carbon materials 12 to form a gel-state mixture thereof, and accordingly, the CNTs 11 maintain the network structure.

Since ionic liquids have high ionic conductivity, high thermal stability, nonvolatility, nonflammability, and nontoxicity, they may be applicable to an electrolyte of the electric double layer capacitor. Also, since ionic liquids have a large available range of electric potential, high energy density of the electric double layer capacitor may be realized.

Also, room temperature ionic liquids may include more cations and anions than ionic liquids below room temperature.

The ionic liquids may include one or more cations such as alkylimidazolium, alkylsulfonium, alkylphosphonium, alkylammonium, alkylpyridinium or alkylpiperidinium. However, the cations of the ionic liquids are not limited thereto.

The ionic liquids may include one or more anions such as BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻, N(COCF₃)(SO₂CF₃)⁻, N(SO₂F)₂⁻, N(CN)₂⁻, (CN)₃⁻, SCN⁻, SeCN⁻, CuCl₂⁻, AlCl₄⁻, or F(HF)_{2.3}⁻. However, the anions of the ionic liquids are not limited thereto.

In general, the electrochemical stability and the electrical conductivity in ionic liquids are contrary to each other. For example, when anions, such as AlCl₄⁻, BF₄⁻, CF₃CO₂⁻, CF₃SO₃⁻, N(SO₂F)₂⁻ or F(HF)_{2.3}⁻, are combined with cations, such as imidazolium or sulfonium, the electrical conductivity is enhanced. When combined with cations, such as tetraalkylammonium, dialkylpyridinium or dialkylpiperidinium, the electrochemical stability is enhanced.

In the case of the ionic liquids 13, 70 to 90 parts by weight of ionic liquids per 100 parts by weight of the entire mixture may be included. When less than 70 parts by weight of ionic liquids are used, gel formation ability may be degraded. When more than 90 parts by weight of ionic liquids are used, capacitance may be reduced.

The biggest defect of an electric double layer capacitor is high resistance due to electrical polarization occurring at the interface between porous carbon materials and an electrolyte. However, according to this embodiment, the ionic liquids 13 act as an electrolyte and concurrently form a gel-state electrode by being mixed with the CNTs 11 and the porous carbon materials 12. Accordingly, the porous carbon materials 12 and the ionic liquids 13 are physically bonded to the network structure formed by the CNTs 11, whereby the possibility of polarization occurrence is low.

Though not illustrated in the drawings, the polarizable electrode may further include conductive materials in order to increase electrical conductivity between the porous carbon materials and the collector. Available conductive materials are not particularly limited, and carbon black or graphite may be used therefor.

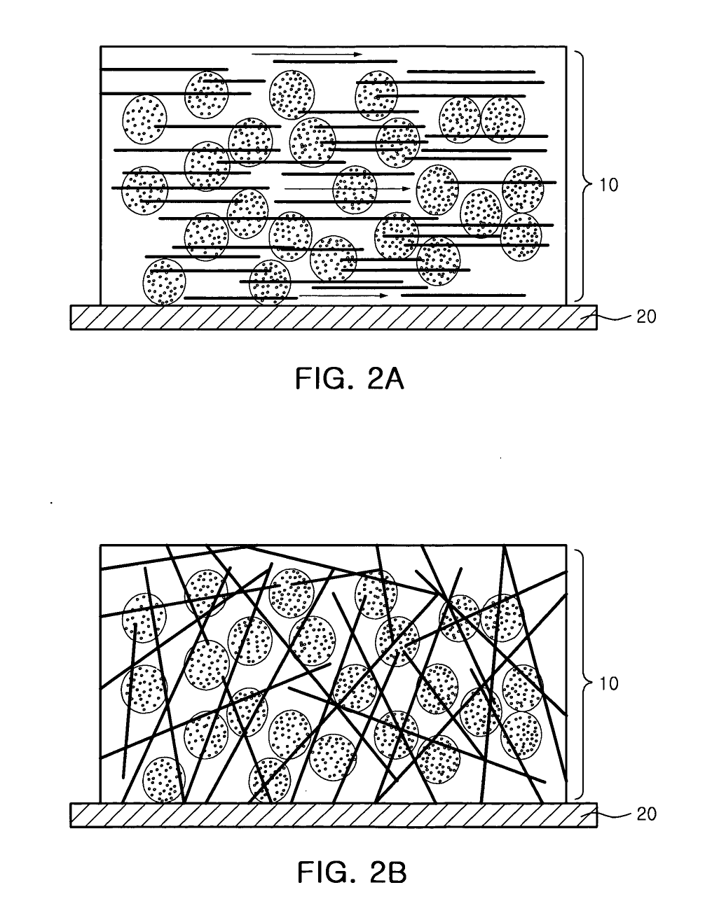

FIG. 2 is a cross-sectional view schematically illustrating an electric double layer capacitor according to an exemplary embodiment of the present invention.

An electric double layer capacitor according to this embodiment includes first and second electrodes 10a and 10b configured as the above-described polarizable electrodes, and an ion permeable separation membrane 30 interposed between the first and second electrodes 10a and 10b.

More specifically, the electric double layer capacitor includes metal cases 40a and 40b having opposite polarity, a pair of collectors 20a and 20b formed in the metal cases 40a and 40b, the first and second electrodes 10a and 10b formed in the collectors 20a and 20b, the ion permeable separation membrane 30 preventing contact between the first and second electrodes 10a and 10b, and gaskets 50a and 50b preventing contact between the metal cases 40a and 40b of opposite polarity.

The ion permeable separation membrane 30 keeps the first and second electrodes from making physical contact therebetween to thereby prevent short circuits. The pair of collectors 20a and 20b store positive and negative charges, respectively, when an electric field is applied from the outside.

The porous carbon materials contained in the first and second electrodes 10a and 10b perform electrical absorption and desorption with cations and anions within ionic liquids. That is, charging is performed as the cations and the anions are respectively adsorbed onto a cathode and an anode when an electric field is applied from the outside, and discharging is performed as the adsorbed ions are desorbed by removing the electric field.

As described above, the first and second electrodes 10a and 10b include the porous carbon materials and the CNTs, so they have high capacitance and low internal resistance.

The electric double layer capacitor according to this embodiment allows the ionic liquids forming the electrodes to act as an electrolyte, so it may not additionally include a separate electrolyte. That is, energy is stored by the absorption and desorption of the cations and the anions contained in the ionic liquids.

Hereinafter, a method of manufacturing the above-described electric double layer capacitor will be described.

First of all, CNTs, porous carbon materials, and ionic liquids are mixed to form a slurry. The types and amount of the CNTs, the porous carbon materials, and the ionic liquids are determined as described above.

A method of mixing the CNTs, the porous carbon materials, and the ionic liquids is not particularly limited. A mixture thereof may be mixed by the use of a grinder or sonication.

In that slurry mixture, the CNTs and the porous carbon materials are dispersed into the ionic liquids to thereby form a gel-state mixture thereof. In that gel-state mixture, the CNTs form a network structure and the porous carbon materials and the ionic liquids are bonded by the physical strength of the network structure.

Next, first and second electrodes are manufactured by casting the mixture into collectors. The collectors are not particularly limited, and metals, such as Al, Cu or Ni—Cr, may be used therefor.

A casting method is not particularly limited. For example, a doctor blade coater, a comma coater, a die coater, a gravure coater or a micro gravure coater may be used.

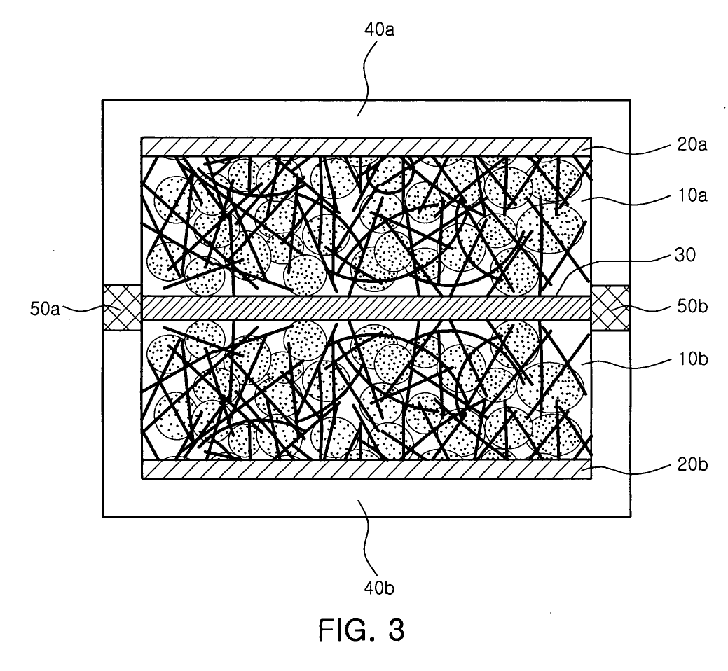

FIG. 3 schematically illustrates a process of casting the mixture into the collector.

As shown in FIG. 3A, the mixture 10 has low viscosity due to applied shear rate, so the application of the mixture 10 is improved. Then, as shown in FIG. 3B, as time goes by, the viscosity of the mixture 10 is regained, and thus the CNTs rebuild the network structure.

The network structure may be easily broken when shear rate is applied, or when the network structure is used for a long time. That is, the gel-state mixture is subject to a reversible sol-gel conversion, which may be adjusted by applied shear rate and viscosity.

The viscosity of the mixture 10 may range from 1 cps to 1000000 cps, and more preferably from 1 cps to 100000 cps, and more preferably from 100 cps to 100000 cps, within the shear rate range from 0.1 to 10000 s⁻¹.

The mixture 10 has thixotropy and a Shear Thinning Ratio (STR) as defined below in Equation 1 in the range of 1 to 10, and more preferably 1.5 to 9. When the STR is less than 1, the sol-gel conversion may be degraded. When the STR is more than 10, it may be difficult to cast the mixture 10 into the collector 20.

$$STR = \frac{{η}_{1}}{{η}_{2}} \qquad Equation 1$$

In the above Equation 1, η₁ is the viscosity of the mixture when applied shear rate is D, η₂ is the viscosity of the mixture when applied shear rate is D×10.

A gel-state electrode material is a viscoelastic material, and it is not broken during a capacitor's manufacturing process. Also, though a dry process of solvent is not performed, the mechanical stability of electrodes may be improved.

After that, the depositing of an ion permeable separation membrane between the first and second electrodes coated on the collectors is performed. Then, all components are subsequently sealed within metal cases. The ion permeable separation membrane may be formed after being impregnated with the same type of ionic liquids as those contained in the first and second electrodes.

After depositing the ion permeable separation membrane, the first and second electrodes and the collectors may be pressurized in order to increase the bonding strength therebetween.

The ionic liquids contained in the first and second electrodes may easily absorb water or moisture. This may have a bad effect on the operations of the electric double layer capacitor. Accordingly, the manufacturing, casting, and sealing process of the slurry mixture may preferably be performed in a moistureless environment.

Also, the slurry mixture may be subject to heat treatment before casting.

### Inventive Example

Hereinafter, the invention will be described in detail through inventive examples. However, the invention is not limited thereto.

CNT and ionic liquid 1-ethyl-3-methylimidazolium Tetrafluoroborate were mixed to become a gel-state mixture. For the CNTs, multi-walled CNTs (CM-95 manufactured by Hanhwa nanotech) having 10 nm to 15 nm in diameter (HR-TEM measurement) and 10 an to 20 μm in length (SEM measurement) were used. The gel-state mixture was mixed with nanoporous carbon having a specific surface area of 1700 m²/g, which is measured by a BET method, and an average particle diameter of 10 μm.

The gel-state mixture was coated on aluminum foil to thereby form first and second electrodes. After depositing a cellulose separation membrane between the first and second electrodes, all components were sealed, and thus an electric double layer capacitor was manufactured. The cellulose separation membrane was used after being impregnated with tetrafluoroborate.

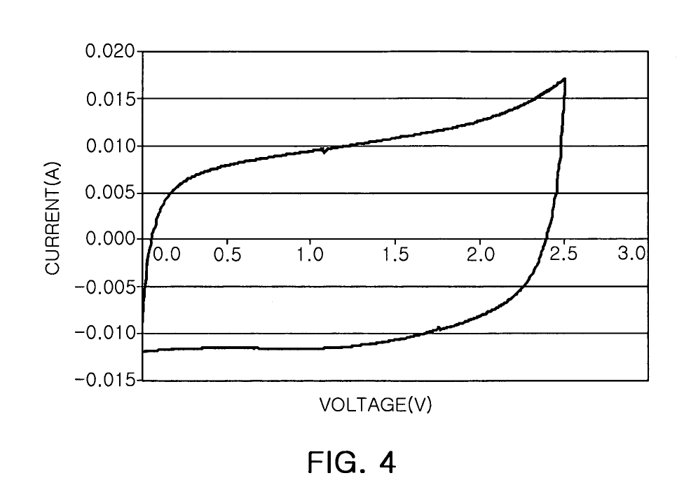

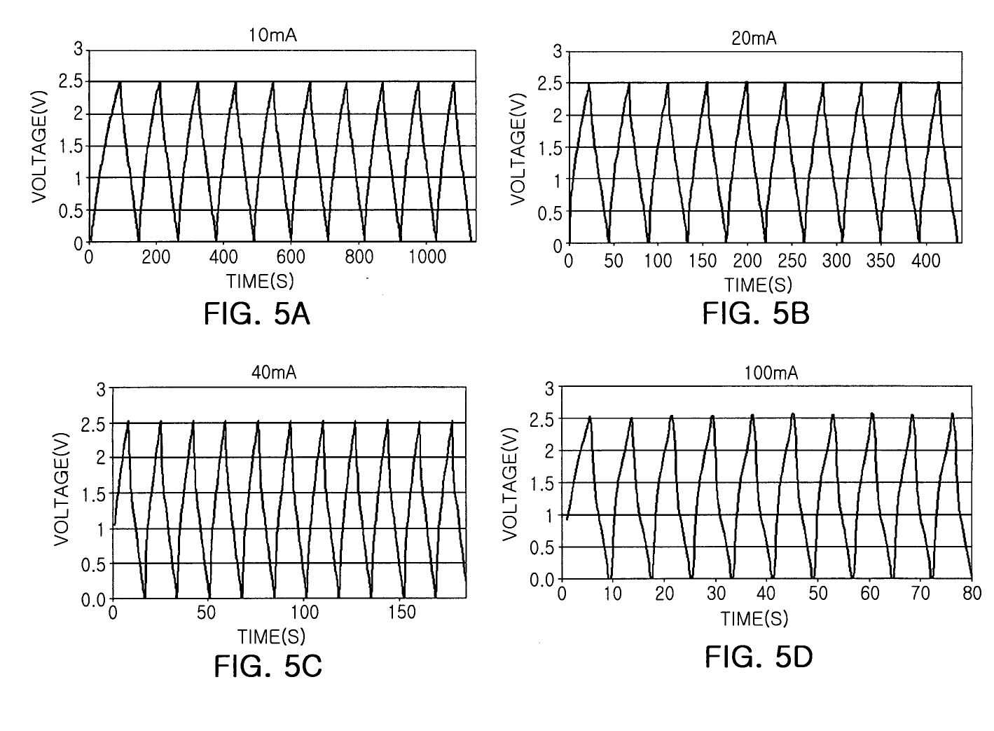

A cyclic voltammetry test was conducted on the manufactured electric double layer capacitor, and its results were shown in FIG. 4. Also, the results of a charging and discharging test according to constant current of 10 mA, 20 mA, 40 mA and 100 mA were shown in FIG. 5.

Capacitance C was obtained by Equation 2. In the case of 10 mA constant current, the capacitance C obtained by using a discharge curve was 0.245 F/cm².

C=I×(dV/dt) Equation 2

In the above Equation 2, I is current, and dV/dt is a gradient of the discharge curve.

Gravimetric specific capacitance C_{g} was obtained by Equation 3. The capacitance C_{g} of the porous carbon materials was 142 F/g, and the capacitance C_{g} of the porous carbon materials and the CNTs was 124 F/g.

C_{g}=2C/m_{AM} Equation 3

In the above Equation 3, C is capacitance according to equation 2, and m_{AM} is the weight of electrode active material.

As set forth above, according to exemplary embodiments of the invention, a polarizable electrode for a capacitor secures an electrical connection path between an electrode and a collector and prevents separation between porous carbon materials and ionic liquids using a network structure formed by CNTs. An electric double layer capacitor having the polarizable electrode has low contact resistance between the electrode and the collector. Also, the ionic liquids act as an electrolyte and concurrently form a gel-state electrode by being mixed with the CNTs and the porous carbon materials. Accordingly, the possibility of polarization occurrence between the electrode and the electrolyte is low. Consequently, the electric double layer capacitor according to this invention has high capacitance and high energy efficiency due to low equivalent series resistance (ESR).

While the present invention has been shown and described in connection with the exemplary embodiments, it will be apparent to those skilled in the art that modifications and variations can be made without departing from the spirit and scope of the invention as defined by the appended claims.

What is claimed is:

1. A polarizable electrode for a capacitor, comprising:
carbon nanotubes forming a network structure;
porous carbon materials dispersed between the carbon nanotubes; and
ionic liquids allowing the carbon nanotubes and the porous carbon materials to be dispersed,
wherein the polarizable electrode is a gel-state mixture.

2. The polarizable electrode of claim 1, wherein the carbon nanotubes have a cylinder shape.

3. The polarizable electrode of claim 1, wherein the carbon nanotubes have a length to diameter ratio of 10:1 or greater.

4. The polarizable electrode of claim 1, wherein the porous carbon materials have an average diameter of 0.1 μm to 100 μm.

5. The polarizable electrode of claim 1, wherein the porous carbon materials have an average diameter of 5 μm to 20 μm.

6. The polarizable electrode of claim 1, wherein the ionic liquids include at least one cation selected from the group consisting of alkylimidazolium, alkylsulfonium, alkylphosphonium, alkylammonium, alkylpyridinium and alkylpiperidinium.

7. The polarizable electrode of claim 1, wherein the ionic liquids include at least one anion selected from the group consisting of BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻, N(COCF₃)(SO₂CF₃)⁻, N(SO₂F)₂⁻, N(CN)₂⁻, (CN)₃⁻, SCN⁻, SeCN⁻, CuCl₂⁻, AlCl₄⁻, and F(HF)_{2.3}⁻.

8. The polarizable electrode of claim 1, further comprising conductive materials.

9. An electric double layer capacitor comprising:
first and second electrodes in a gel state including carbon nanotubes forming a network structure, porous carbon materials dispersed between the carbon nanotubes, and ionic liquids allowing the carbon nanotubes and the porous carbon materials to be dispersed; and
an ion permeable separation membrane interposed between the first and second electrodes.

10. A method of manufacturing an electric double layer capacitor, the method comprising:
manufacturing a gel-state mixture by mixing carbon nanotubes, porous carbon materials, and ionic liquids;
manufacturing first and second electrodes by casting the mixture into collectors; and
depositing an ion permeable separation membrane between the first and second electrodes and sealing all components.

11. The method of claim 10, wherein the carbon nanotubes comprise 0.1 to 10 parts by weight of the carbon nanotubes per 100 parts by weight of the mixture.

12. The method of claim 10, wherein the porous carbon materials comprise 5 to 20 parts by weight of the porous carbon materials per 100 parts by weight of the mixture.

13. The method of claim 10, wherein the ionic liquids comprise 70 to 90 parts by weight of the ionic liquids per 100 parts by weight of the mixture.

14. The method of claim 10, wherein the mixture has viscosity in a range of 10 cps to 1000000 cps within the shear rate range from 0.1 to 10000 s⁻¹.

15. The method of claim 10, wherein the mixture has viscosity in a range of 1 cps to 100000 cps within the shear rate range from 0.1 to 10000 s⁻¹.

16. The method of claim 10, wherein the mixture has a Shear Thinning Ratio (STR) in a range of 1 to 10, the STR being expressed by Equation 1:
$$STR = \frac{{η}_{1}}{{η}_{2}} \qquad Equation 1$$
where η₁ is a viscosity of the mixture when applied shear rate is D, and
η₂ is a viscosity of the mixture when applied shear rate is D×10.

17. The method of claim 10, wherein the ion permeable separation membrane is deposited after being impregnated with the ionic liquids.

18. The method of claim 10, wherein each manufacturing process of the electric double layer capacitor is performed in a moistureless environment.
